(19) United States
(12) Patent Application Publication
(10) Pub. No.: US 2013/0112709 A1
(43) Pub. Date: May 9, 2013

(54) MELTING SYSTEM

(71) Applicant: Graco Minnesota Inc., Minneapolis, MN (US)

(72) Inventors: Daniel P. Ross, Maplewood, MN (US); Paul R. Quam, Brooklyn Center, MN (US)

(73) Assignee: GRACO MINNESOTA INC., Minneapolis, MN (US)

(21) Appl. No.: 13/671,025

(22) Filed: Nov. 7, 2012

Related U.S. Application Data
(60) Provisional application No. 61/556,586, filed on Nov. 7, 2011.

(51) Int. Cl. B67D 7/80; H05B 3/00; B05C 5/00

(52) U.S. Cl. CPC H05B 3/0004; B05C 5/001
USPC 222/146.5; 219/221

(57) ABSTRACT

A hot melt dispensing system includes a container for storing solid hot melt material, a hot press melter having a loading position for receiving solid hot melt material and a melting position for applying heat and pressure to liquefy the hot melt material, a feed system for transporting solid hot melt material from the container to the hot press melter and a dispensing system for administering the liquefied hot melt material.

### CROSS-REFERENCE TO RELATED APPLICATION(S)

This application claims priority to U.S. Provisional Application No. 61/556,586, filed on Nov. 7, 2011 and entitled “PRE-MELTER”.

### BACKGROUND

The present disclosure relates generally to systems for dispensing hot melt adhesive. More particularly, the present disclosure relates to a melting system for preparing liquid hot melt adhesive.

Hot melt dispensing systems are typically used in manufacturing assembly lines to automatically disperse an adhesive used in the construction of packaging materials such as boxes, cartons and the like. Hot melt dispensing systems conventionally comprise a material tank, heating elements, a pump and a dispenser. Solid polymer pellets are melted in the tank using a heating element before being supplied to the dispenser by the pump. Because the melted pellets will re-solidify into solid form if permitted to cool, the melted pellets must be maintained at temperature from the tank to the dispenser. This typically requires placement of heating elements in the tank, the pump and the dispenser, as well as heating any tubing or hoses that connect those components. Furthermore, conventional hot melt dispensing systems typically utilize tanks having large volumes so that extended periods of dispensing can occur after the pellets contained therein are melted. However, the large volume of pellets within the tank requires a lengthy period of time to completely melt, which increases start-up times for the system. For example, a typical tank includes a plurality of heating elements lining the walls of a rectangular, gravity-fed tank such that melted pellets along the walls prevents the heating elements from efficiently melting pellets in the center of the container. The extended time required to melt the pellets in these tanks increases the likelihood of “charring” or darkening of the adhesive due to prolonged heat exposure.

### SUMMARY

A hot melt dispensing system includes a container for storing solid hot melt material, a hot press melter having a loading position for receiving solid hot melt material and a melting position for applying heat and pressure to liquefy the hot melt material, a feed system for transporting solid hot melt material from the container to the hot press melter and a dispensing system for administering the liquefied hot melt material.

A hot press melting apparatus includes a first heated plate, a second heated plate aligned with the first heated plate and having a drain and a perforated plate located between the first heated plate and the second heated plate for allowing liquefied hot melt material to pass through the perforated plate to the drain but preventing solid hot melt material from passing through the perforated plate. The first heated plate is spaced from the perforated plate by a first distance in an accelerated melting position, and the first heated plate is spaced from the perforated plate by a second distance greater than the first distance in a loading position.

Solid hot melt material is melted using a melting device having opposed first and second heated plates. A method includes heating the first plate and the second plate, feeding the solid hot melt material to a region between the first plate and the second plate, pressing the first plate and the second plate together while heating the first and second plates to press the solid hot melt material against the first plate and the second plate to increase a melting rate of the solid hot melt material, and removing liquefied hot melt material from the second plate and the region between the first plate and the second plate.

### BRIEF DESCRIPTION OF THE DRAWINGS

FIG. 1 is a schematic view of a system for dispensing hot melt adhesive.

FIG. 2 is a schematic view of a hot press melter within the system of FIG. 1.

FIG. 3A is a perspective view of one embodiment of the hot press melter of FIG. 2 in a loading position.

FIG. 3B is a perspective view of one embodiment of the hot press melter of FIG. 2 in an accelerated melting position.

FIG. 4 is a perspective view of another embodiment of part of the hot press melter of FIG. 2.

FIG. 5 is a perspective view of one embodiment of a heated plate suitable for use in the hot press melter of FIG. 2.

### DETAILED DESCRIPTION

Conventional hot melt dispensing systems do not typically have short startup times. The system components generally need to be “warmed up” (heated to reach operating temperatures) before dispensing can commence. Additionally, the solid hot melt material to be dispensed must be heated to form a liquid so that it can flow through the system and be dispensed. In most systems, the solid hot melt material is added to a melting vessel, often as a large solid mass. In these systems, melting the solid hot melt material takes significant time. The invention described herein provides a melting system that can quickly liquefy hot melt material.

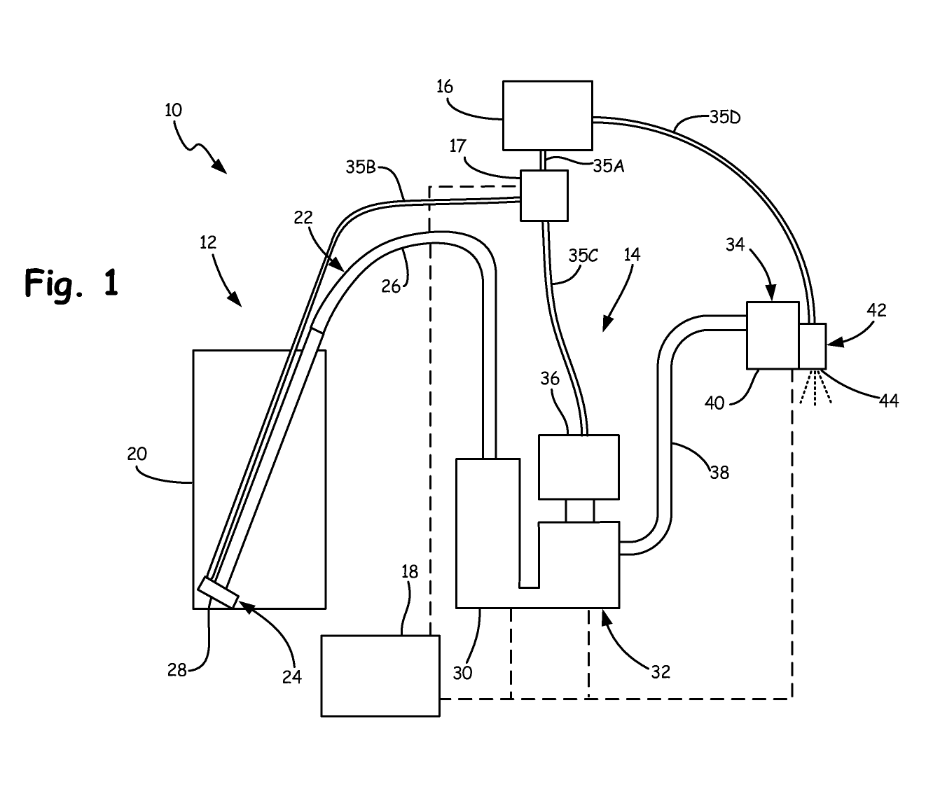

FIG. 1 is a schematic view of system 10, which is a system for dispensing hot melt adhesive. System 10 includes cold section 12, hot section 14, air source 16, air control valve 17, and controller 18. In the embodiment shown in FIG. 1, cold section 12 includes container 20 and feed assembly 22, which includes vacuum assembly 24, feed hose 26, and inlet 28. In the embodiment shown in FIG. 1, hot section 14 includes melt system 30, pump 32, and dispenser 34. Air source 16 is a source of compressed air supplied to components of system 10 in both cold section 12 and hot section 14. Air control valve 17 is connected to air source 16 via air hose 35A, and selectively controls air flow from air source 16 through air hose 35B to vacuum assembly 24 and through air hose 35C to motor 36 of pump 32. Air hose 35D connects air source 16 to dispenser 34, bypassing air control valve 17. Controller 18 is connected in communication with various components of system 10, such as air control valve 17, melt system 30, pump 32, and/or dispenser 34, for controlling operation of system 10.

Components of cold section 12 can be operated at room temperature, without being heated. Container 20 can be a hopper for containing a quantity of solid adhesive pellets (solid hot melt material) for use by system 10. Suitable adhesives can include, for example, a thermoplastic polymer glue such as ethylene vinyl acetate (EVA) or metallocene-based hot melt adhesives. Feed assembly 22 connects container 20 to hot section 14 for delivering the solid adhesive pellets from container 20 to hot section 14. Feed assembly 22 includes vacuum assembly 24 and feed hose 26. Vacuum assembly 24 is positioned in container 20. Compressed air from air source 16 and air control valve 17 is delivered to vacuum assembly 24 to create a vacuum, inducing flow of solid adhesive pellets into inlet 28 of vacuum assembly 24 and then through feed hose 26 to hot section 14. Feed hose 26 is a tube or other passage sized with a diameter substantially larger than that of the solid adhesive pellets to allow the solid adhesive pellets to flow freely through feed hose 26. Feed hose 26 connects vacuum assembly 24 to hot section 14.

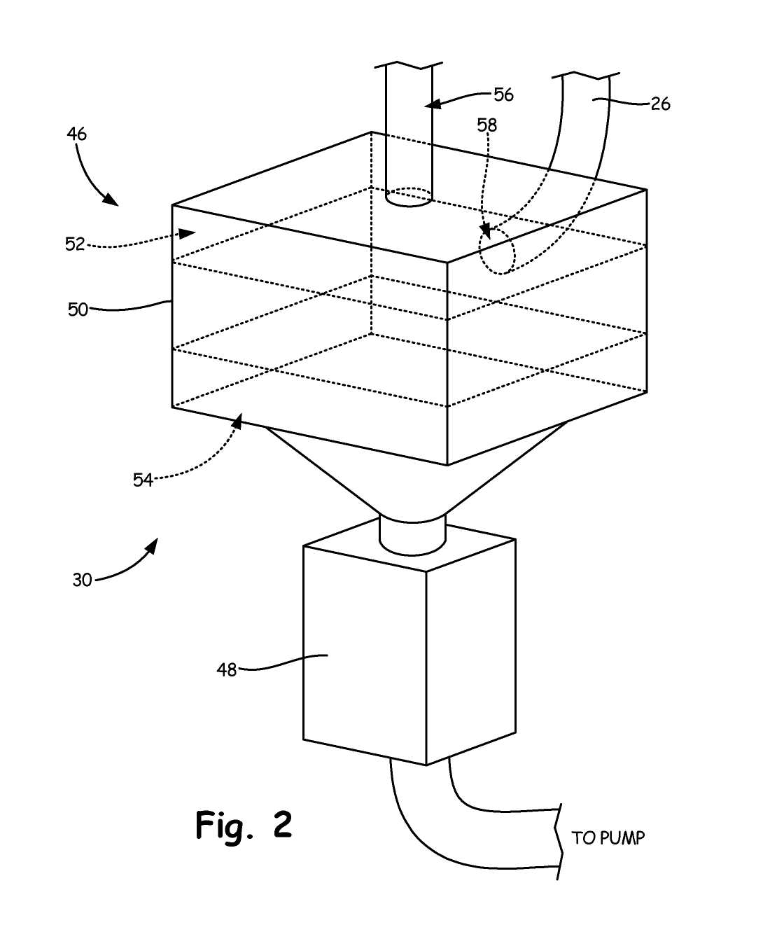

Solid adhesive pellets are delivered from feed hose 26 to melt system 30. Melt system 30 can include a container (melter 46, shown in FIG. 2) and resistive heating elements (not shown) for melting the solid adhesive pellets to form a hot melt adhesive in liquid form (liquefied hot melt material). Melt system 30 can be sized to have a relatively small adhesive volume, for example about 0.5 liters, and configured to melt solid adhesive pellets in a relatively short period of time. Pump 32 is driven by motor 36 to pump hot melt adhesive from melt system 30 to dispenser 34 through supply hose 38. Motor 36 can be an air motor driven by pulses of compressed air from air source 16 and air control valve 17. Pump 32 can be a linear displacement pump driven by motor 36. In the illustrated embodiment, dispenser 34 includes manifold 40 and module 42. Hot melt adhesive from pump 32 is received in manifold 40 and dispensed via module 42. Dispenser 34 can selectively discharge hot melt adhesive whereby the hot melt adhesive is sprayed out outlet 44 of module 42 onto an object, such as a package, a case, or another object benefiting from hot melt adhesive dispensed by system 10. Module 42 can be one of multiple modules that are part of dispenser 34. In an alternative embodiment, dispenser 34 can have a different configuration, such as a handheld gun-type dispenser. Some or all of the components in hot section 14, including melt system 30, pump 32, supply hose 38, and dispenser 34, can be heated to keep the hot melt adhesive in a liquid state throughout hot section 14 during the dispensing process.

System 10 can be part of an industrial process, for example, for packaging and sealing cardboard packages and/or cases of packages. In alternative embodiments, system 10 can be modified as necessary for a particular industrial process application. For example, in one embodiment (not shown), pump 32 can be separated from melt system 30 and instead attached to dispenser 34. Supply hose 38 can then connect melt system 30 to pump 32.

FIG. 2 is a schematic view of one embodiment of melt system 30. Melt system 30 includes hot press melter 46 and liquid adhesive reservoir 48. Hot press melter 46 receives solid adhesive pellets from feed assembly 22 and melts the pellets to form liquid hot melt adhesive, which exits melter 46 and enters liquid adhesive reservoir 48.

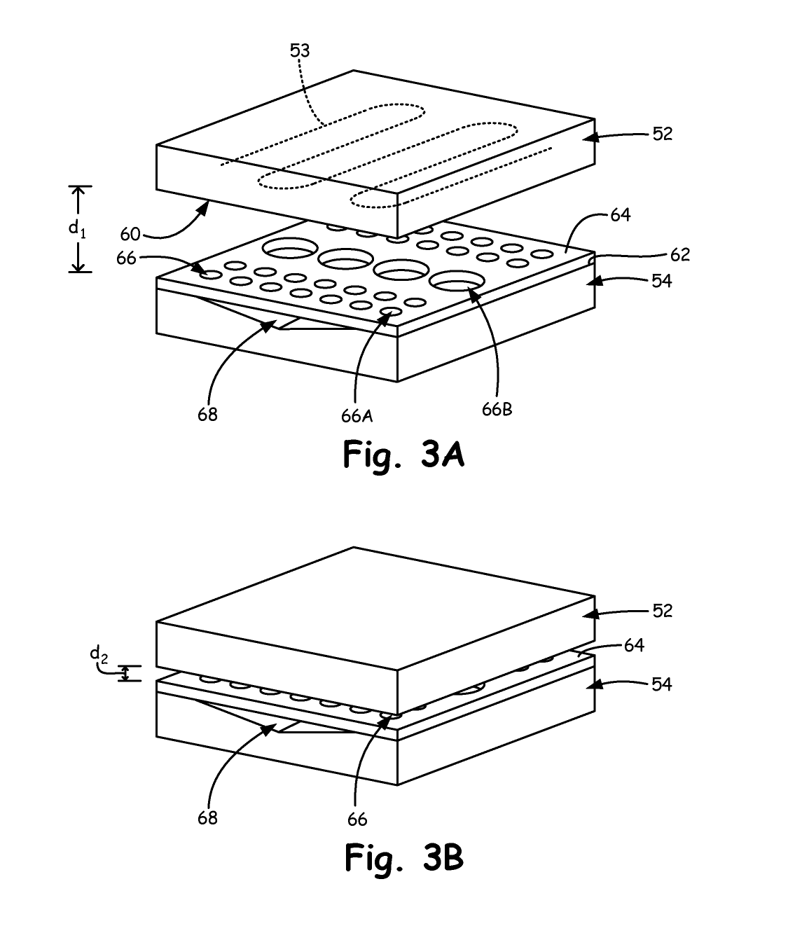

As shown in FIG. 2, hot press melter 46 includes housing 50, first heated plate 52, second heated plate 54 and press drive 56. Housing 50 encloses first and second heated plates 52 and 54 and also includes opening 58, where solid adhesive pellets from feed assembly 22 (or some other source) are introduced into hot press melter 46. First heated plate 52 is a plate capable of transferring heat to hot press melter 46. In some embodiments, first heated plate 52 contains a heating element (heating element 53 shown in FIG. 3A). Exemplary heating elements include, but are not limited to, resistive heating elements, heaters cast within the plate and cartridge heaters. In other embodiments, first heated plate 52 conducts heat from a separate heat source to hot press melter 46. During operation, first heated plate 52 generally has a temperature between 200° F. (93° C.) and 450° F. (232° C.), depending on the type of hot melt material being melted. Second heated plate 54 is similar to first heated plate 52. Second heated plate 54 is a plate capable of transferring heat to hot press melter 46. In some embodiments, second heated plate 54 contains a heating element. Exemplary heating elements include, but are not limited to, resistive heating elements, heaters cast within the plate and cartridge heaters. In other embodiments, second heated plate 54 conducts heat from a separate heat source to hot press melter 46. During operation, second heated plate 54 generally has a temperature between 200° F. (93° C.) and 450° F. (232° C.), depending on the type of hot melt material being melted. In exemplary embodiments, first and second heated plates 52 and 54 are metallic. Solid adhesive pellets are melted in melter 46 by transferring heat from first and second heated plates 52 to the pellets. During operation, first and second heated plates 52 are pressed together to increase the contact surface area between the adhesive pellets and plates 52 and 54, thereby increasing the melting rate of the adhesive pellets.

Press drive 56 controls the position(s) of one or more of the first and second heated plates 52 and 54. In the embodiment illustrated in FIG. 2, press drive 56 controls the position of first heated plate 52 within housing 50 and with respect to second heated plate 54. Press drive 56 can include a rod (as shown) or a similar structure having one end attached to first heated plate 52 and the other end attached to a device capable of motion. In some embodiments, the position of first heated plate 52 is controlled using a motor, an actuator, pneumatics and the like. In FIG. 2, hot press melter 46 is shown in an open or loading position with first heated plate 52 spaced from second heated plate 54. First heated plate 52 is located above opening 58 while second heated plate 54 is located below opening 58. Solid adhesive pellets are able to enter melter 46 through opening 58 while hot press melter 46 is in the loading position. Solid adhesive pellets enter melter 46 between first heated plate 52 and second heated plate 54. Once a sufficient amount of solid adhesive pellets has entered hot press melter 46, press drive 56 moves first heated plate 52 towards second heated plate 54. Reducing the distance between first heated plate 52 and second heated plate 54 increases the surface area of first and second heated plates 52 and 54 exposed to the solid adhesive pellets, allowing more heat to be transferred to the adhesive and increasing the rate of melting. More specifically, first and second heated plates 52 and 54 press the solid adhesive pellets, thereby thinning the mass of pellets so that the pellets contact more of the surface area of first and second heated plates 52 and 54.

FIGS. 3A and 3B illustrate one embodiment of hot press melter 46. Housing 50 has been removed from FIGS. 3A and 3B to better illustrate first and second heated plates 52 and 54. First heated plate 52 includes first side 60 and second heated plate 54 includes second side 62 that faces first side 60. FIG. 3A illustrates first and second heated plates 52 and 54 in the open or loading position while FIG. 3B illustrates first and second heated plates 52 and 54 in the closed or accelerated melting position. In the loading position, first side 60 of first heated plate 52 is spaced from second side 62 of second heated plate 54 by distance d₁. In the accelerated melting position, first side 60 of first heated plate 52 is spaced from second side 62 of second heated plate 54 by distance d₂ which is smaller than d₁.

In addition to first and second heated plates 52 and 54, hot press melter 46 shown in FIGS. 3A and 3B also includes perforated plate 64. Perforated plate 64 is positioned atop second heated plate 54 along second side 62. When solid adhesive pellets enter hot press melter 46, the pellets are initially located between first heated plate 52 and perforated plate 64. Perforated plate 64 contains perforations 66. Perforations 66 can be circular, oval, rectangular or irregularly shaped. Perforations 66 are sized to be smaller than the solid adhesive pellets added to hot press melter 46. For example, in the case of generally circular perforations and pellets, perforations 66 generally have a diameter larger than the diameter of the solid adhesive pellets added to hot press melter 46. Liquefied hot melt adhesive is able to flow through perforations 66, but the solid adhesive pellets are unable to pass through perforated plate 64 because the pellets are too large to pass through perforations 66. Thus, perforated plate 64 prevents the passage of hot melt material until the material has begun melting. In some embodiments, perforated plate 64 includes a heating element, such as those described with respect to first and second heated plates 52 and 54. Alternatively, perforated plate 64 can simply be heated conductively by second heated plate 54.

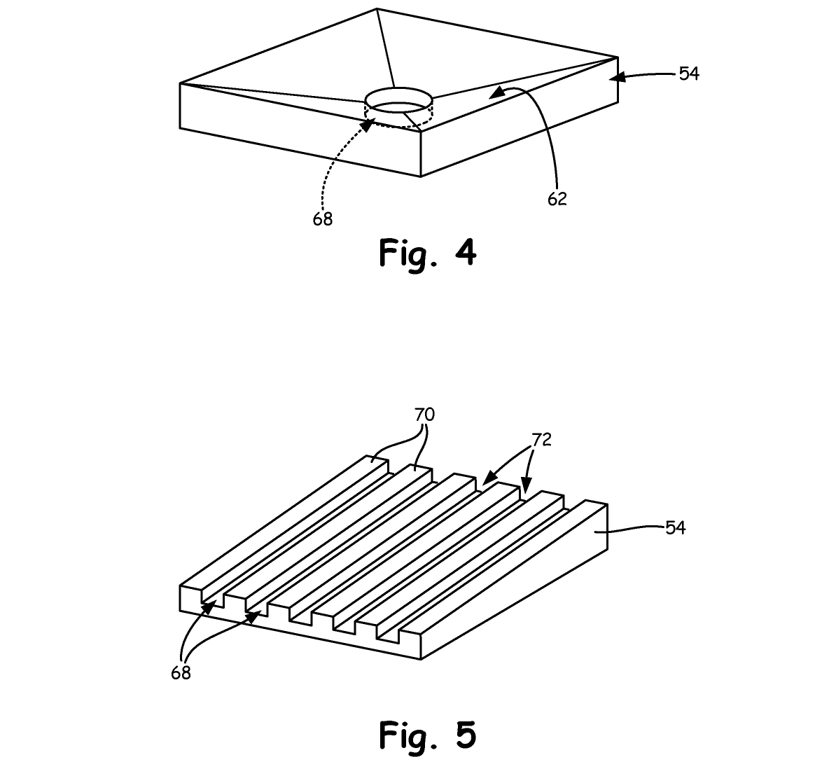

Second heated plate 54 includes drain 68. In the embodiment illustrated in FIG. 3A, drain 68 is located between the body of second heated plate 54 and perforated plate 64. Gravity and the pressure created by moving first heated plate 52 toward second heated plate 54 causes liquefied (melted) hot melt adhesive to pass through perforations 66 of perforated plate 34. The liquid hot melt adhesive is routed to drain 68 where it flows out of hot press melter 46. In the embodiment shown in FIGS. 3A and 3B, drain 68 is located on one side of second heated plate 54. Liquid hot melt adhesive that has passed through perforated plate 64 exits melter 46 through drain 68 and flows to liquid adhesive reservoir 48 (shown in FIG. 2). In alternate embodiments, drain 68 is a conical or funnel-like drain that has a drain opening in the bottom of second heated plate 34 (see FIG. 4, shown without perforated plate 64).

In some embodiments, perforations 66 all have roughly the same size. In other embodiments, perforated plate 64 contains perforations 66 of different sizes. As shown in FIG. 3A, perforations 66A are smaller than perforations 66B. Perforations 66A and 66B both prevent solid adhesive pellets of a size larger than perforations 66B from passing through perforated plate 64. The smaller perforations (perforations 66A) further restrict the passage of solid adhesive pellets. Additionally, the smaller perforations also mean that more surface area of perforated plate 64 is available to contact the solid adhesive pellets, providing additional opportunity for heat transfer from perforated plate 64 to the solid adhesive pellets. In some embodiments, perforations 66A have an average diameter of about 2 millimeters to prevent solid adhesive pellets having a diameter of about 5 millimeters from passing through perforated plate 64, while perforations 66B have an average diameter of about 4 millimeters to prevent solid adhesive pellets having a diameter of about 8 millimeters from passing through perforated plate 64. For non-circular perforations 66, the above average diameter values apply to the average lengths and/or widths of the perforations.

During operation, solid adhesive pellets (or pillows) are added to melter 46 between first heated plate 52 and perforated plate 64 through opening 58 while melter 46 is in a loading position. Once the pellets have been added to hot press melter 46, the pellets begin melting due to the heat transferred from first and second heated plates 52 and 54 and perforated plate 64 to the pellets. When hot press melter 46 is in the open position, heat is transferred to the pellets conductively by perforated plate 64 and/or second heated plate 54 and convectively by first heated plate 52. The rate of melting is increased by moving first heated plate 52 towards perforated plate 64 and second heated plate 54 in an accelerated melting position. By reducing the distance between first side 60 of first heated plate 52 and second side 62 of second heated plate 54, the pellets are pressed and brought into contact with additional heated surfaces (first side 60, perforated plate 64 and second side 62). The pressed pellets are spread out over a greater surface area of first side 60 of first heated plate 52 and second side 62 of second heated plate 54 to provide greater area for heat transfer. Pressing the pellets eliminates “dead space” on the heating surfaces of first and second plates 52 and 54. Heat is conductively transferred from these surfaces to the now partly compressed pellets. When hot press melter 46 is in the accelerated melting position, heat is transferred to the pellets conductively by first heated plate 52, perforated plate 64 and/or second heated plate 54, leading to an increased rate of melting.

Liquefied hot melt adhesive passes through perforated plate 64 and exits hot press melter 46 through drain 68 in second heated plate 54 and enters liquid adhesive reservoir 48. Liquid adhesive reservoir 48 communicates with pump 32 so that the liquid hot melt adhesive can be pumped from liquid adhesive reservoir 48 to dispenser 34 where it is dispensed. Liquid adhesive reservoir 48 is a vessel that maintains the hot melt adhesive in a liquid state. In some embodiments, liquid adhesive reservoir 48 is large enough to hold a surplus of liquid hot melt adhesive to ensure that pump 32 has a sufficient supply to operate continuously for a predetermined amount of time, such as between cycles of the loading position and the accelerated melting position for hot press melter 46. In other embodiments, liquid adhesive reservoir 48 is smaller and functions merely as a conduit between hot press melter 46 and pump 32. In either case, liquid adhesive reservoir 48 can be actively heated by heating elements to ensure that the hot melt adhesive remains in a liquid state. In some embodiments, liquid adhesive reservoir 48 is a secondary melter that transfers heat to the hot melt adhesive within the reservoir to further melt any partially solid adhesive that exited hot press melter 46.

Once the solid adhesive pellets have been melted in hot press melter 46, hot press melter 46 transitions from the accelerated melting position to the open position to allow additional solid adhesive pellets to enter melter 46. Press drive 56 causes first heated plate 52 to move away from perforated plate 64 and second heated plate 54 until hot press melter 46 is again in the open position. The cycle begins anew and solid adhesive pellets are added to hot press melter 46 through opening 58. In some embodiments, melter 46 cycles between the open position and the accelerated melting position between once every five seconds and once every five minutes. The cycle time depends on factors that include the size of hot press melter 46, the size of the solid adhesive pellets, the melting temperature of the solid adhesive pellets and the temperature of hot press melter 46. Generally, the cycle time and the quantity of solid adhesive pellets delivered to hot press melter 46 are sufficient to permit pump 32 to run continuously.

FIG. 5 illustrates another embodiment of a heated plate suitable for use in hot press melter 46. While FIGS. 3A, 3B and 4 illustrate perforated plate 64 atop second heated plate 54, the embodiment shown in FIG. 5 does not possess a perforated plate. Instead, second heated plate 54A contains surface features that increase the surface area of second heated plate 54A that can be exposed to the hot melt adhesive. Surface features include, but are not limited to, ribs, channels, dimples, indentations and combinations thereof. Second heated plate 54A shown in FIG. 5 includes ribs 70 that form channels 72 on second side 62. Solid adhesive pellets entering hot press melter 46 are fed by gravity into channels 72. Channels 72 are sloped to one side of second heated plate 54A to direct liquid hot melt adhesive to drains 68 where it exits melter 46. In some embodiments, first heated plate 52 (not shown) can have complimentary surface features. For example, ribs on first heated plate 52 can fit into channels 72 on second heated plate 54A and vice versa.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims.

1. A hot melt dispensing system comprising:
a container for storing solid hot melt material;
a hot press melter having a loading position for receiving solid hot melt material and a melting position for applying heat and pressure to liquefy the hot melt material;
a feed system for transporting solid hot melt material from the container to the hot press melter; and
a dispensing system for administering the liquefied hot melt material.

2. The system of claim 1, wherein the hot press melter comprises:
a first heated plate having a first side;
a second heated plate having a second side generally opposite the first side; and
a press drive for varying a distance between the first side of the first heated plate and the second side of the second heated plate to receive hot melt material between the first and second plates in the loading position and to apply pressure and heat to liquefy the hot melt material in the melting position;

3. The system of claim 1, wherein the first heated plate and the second heated plate each comprise a heating element selected from the group consisting of cast heaters, resistive heating elements and cartridge heaters.

4. The system of claim 1, wherein the second plate further comprises a drain for removing the liquefied hot melt material from the melter.

5. The system of claim 4, wherein the melter further comprises:
a perforated plate located between the first plate and the second plate for preventing solid hot melt pellets from entering the drain, but allowing liquefied hot melt material to enter the drain.

6. The system of claim 5, wherein the perforated plate comprises:
first perforations having a first average diameter for preventing solid hot melt material having a diameter of about 5 millimeters from passing through the perforated plate; and
second perforations having a second average diameter larger than the first average diameter for preventing solid hot melt material having a diameter of about 8 millimeters from passing through the perforated plate.

7. The system of claim 5, wherein the perforated plate comprises a heating element selected from the group consisting of cast heaters, resistive heating elements and cartridge heaters.

8. The system of claim 1, wherein the second plate comprises a surface feature that increases the surface area of the second plate to which hot melt material are exposed, wherein the surface feature is selected from the group consisting of ribs, channels, dimples, indentations and combinations thereof.

9. The system of claim 4, wherein the drain comprises a drain opening in a bottom surface of the second plate.

10. The system of claim 4, wherein the drain allows liquefied hot melt material to flow off of the second plate along a side of the second plate.

11. A hot press melting apparatus comprising:
a first heated plate;
a second heated plate aligned with the first heated plate and having a drain; and
a perforated plate located between the first heated plate and the second heated plate for allowing liquefied hot melt material to pass through the perforated plate to the drain but preventing solid hot melt material from passing through the perforated plate, wherein the first heated plate is spaced from the perforated plate by a first distance in an accelerated melting position, and wherein the first heated plate is spaced from the perforated plate by a second distance greater than the first distance in a loading position.

12. The apparatus of claim 11, wherein the first heated plate and the second heated plate each comprise a heating element selected from the group consisting of cast heaters, resistive heating elements and cartridge heaters.

13. The apparatus of claim 11, wherein the perforated plate comprises a heating element selected from the group consisting of cast heaters, resistive heating elements and cartridge heaters.

14. The apparatus of claim 11, wherein the perforated plate comprises:
first perforations having a first average diameter for preventing solid hot melt material having a diameter of about 5 millimeters from passing through the perforated plate; and
second perforations having a second average diameter larger than the first average diameter for preventing solid hot melt material having a diameter of about 8 millimeters from passing through the perforated plate.

15. The apparatus of claim 11, wherein the drain comprises a drain opening in a bottom surface of the second plate.

16. The apparatus of claim 11, wherein the drain allows liquefied hot melt material to exit the second plate along a side of the second plate.

17. The apparatus of claim 11, further comprising:
a press drive for moving at least one of the first and second plates between the loading position and the accelerated melting position.

18. A method for melting a solid hot melt material using a melting device having opposed first and second heated plates, the method comprising:
heating the first plate and the second plate;
feeding the solid hot melt material to a region between the first plate and the second plate;
pressing the first plate and the second plate together while heating the first and second plates to press the solid hot melt material against the first plate and the second plate to increase a melting rate of the solid hot melt material; and
removing liquefied hot melt material from the melting device.

19. The method of claim 18, wherein the first and second plates are pressed together and heated for between 5 seconds and 5 minutes.

20. The method of claim 18, further comprising:
positioning a perforated plate between the first and second plates to allow liquefied hot melt material to flow through the perforated plate to the second plate while substantially preventing solid material from reaching the second plate.

21. The method of claim 18, wherein pressing the solid hot melt material against the first plate and the second plate increases a contact surface area between the solid hot melt material and the first and second plates.
